(19) United States
(12) Patent Application Publication
(10) Pub. No.: US 2026/0164314 A1
(43) Pub. Date: Jun. 11, 2026

(54) SYSTEMS AND METHODS FOR FALLBACK IN FIFTH GENERATION NETWORKS

(71) Applicant: Verizon Patent and Licensing Inc., Basking Ridge, NJ (US)

(72) Inventors: Jeremy Nacer, Boca Raton, FL (US); Yong Sang Cho, Old Tappan, NJ (US); Sudhir Patel, Boonton, NJ (US)

(21) Appl. No.: 18/970,452

(22) Filed: Dec. 5, 2024

(51) Int. Cl. H04W 36/00; H04W 36/08

(52) U.S. Cl. CPC H04W 36/00222; H04W 36/0058; H04W 36/08

(57) ABSTRACT

A user equipment (UE) device may include a processor configured to detect a fallback condition, wherein the fallback condition indicates that the UE device is to perform a fallback handover from a New Radio (NR) cellular wireless connection to a Long Term Evolution (LTE) cellular wireless connection. The processor may be further configured to select a fallback condition information code based on the detected fallback condition; send the selected fallback condition information code to an NR base station associated with the UE device; receive an instruction from the NR base station to connect to an LTE base station; and connect to the LTE base station in response to receiving the instruction to connect to the LTE base station.

### BACKGROUND INFORMATION

To satisfy the needs and demands of users of mobile communication devices, providers of wireless communication services continue to improve and expand available services as well as networks used to deliver such services. One aspect of such improvements includes enabling mobile communication devices to maintain a connection to a network in light of changing conditions. Managing connections in different situations may pose various difficulties.

### BRIEF DESCRIPTION OF THE DRAWINGS

FIG. 1 illustrates an environment according to an implementation described herein;

FIG. 2 illustrates exemplary components of a device that may be included in an environment according to an implementation described herein;

FIG. 3 illustrates exemplary components of a user equipment (UE) device according to an implementation described herein;

FIG. 4 illustrates exemplary components of a base station according to an implementation described herein;

FIG. 5 illustrates exemplary components of a fallback conditions database according to an implementation described herein;

FIG. 6 illustrates a flowchart of a process for reporting a fallback condition according to an implementation described herein;

FIG. 7 illustrates a flowchart of a process for performing a handover based on a fallback condition according to an implementation described herein; and

FIG. 8 illustrates an exemplary signal flow diagram according to an implementation described herein.

### DETAILED DESCRIPTION OF PREFERRED EMBODIMENTS

The following detailed description refers to the accompanying drawings. The same reference numbers in different drawings identify the same or similar elements.

Providers of wireless communication services operate radio access networks (RANs) that include base stations. The base stations enable cellular wireless communication devices (e.g., smart phones, etc.), referred to as user equipment (UE) devices (also herein referred to as UEs), to connect to networks and obtain services via the provider's core network, such as a Fourth Generation (4G) core network, a Fifth Generation (5G) core network, and/or other next generation networks as defined by the 3^{rd} Generation Partnership Project (3GPP). 5G coverage may be provided using 5G base stations, referred to as gNodeBs, implementing the 5G New Radio (NR) Radio Access Technology (RAT). 4G coverage may be provided using 4G base stations, referred to as eNodeBs, implementing the 4G Long Term Evolution (LTE) RAT. In order to establish a communication session in 5G, a UE device may establish a Protocol Data Unit (PDU) session in the core network, via the RAN. The PDU session may enable the UE device to communicate with another network via the RAN and core networks. The UE device may then establish one or more data flows in the PDU session. Each data flow may be associated with a Quality of Service (QoS) and/or other types of service requirements and may also be referred to as a “QoS data flow” or a “QoS flow.”

A UE device connected to a RAN using 5G NR may experience a problem that requires switching to a 4G LTE connection. The mechanism for switching from a 5G NR connection to a 4G LTE connection is referred to as a fallback. A fallback may be performed as an inter-RAT handover that may maintain existing sessions for the UE device, or as a Release with Redirection, in which the UE device releases the 5G NR connection and then connects to a 4G LTE base station. A fallback may be performed for various reasons, such as the UE device exiting a 5G NR coverage area or the signal quality of the 5G NR connection lowering as a result of interference.

Another cause of fallback may be overheating of a UE device. A UE device connected to the NR spectrum may experience more battery usage, which may increase the chances of device overheating. An overheating condition may be addressed by reducing power usage by the UE device, such as by reducing the number of component carriers, reducing the number of Multiple Input and Multiple Output (MIMO) layers, and/or otherwise reducing the power consumption of the wireless transceiver of the UE device. If the UE device continues to remain in an overheating condition after minimizing the number of component carriers and/or MIMO layers, the UE device may trigger a dropped call/connection on the NR connection and select to connect to an LTE base station. Dropped calls/connections may result in a poor user experience and impact network resources by causing increased signaling and/or overhead.

Implementations described herein relate to systems and methods for fallback in wireless communication networks, such as 5G networks or other next generation networks. A UE device may be configured to detect a fallback condition that indicates that the UE device is to perform a fallback handover from an NR cellular wireless connection to an LTE cellular wireless connection, select a fallback condition information code based on the detected fallback condition, and send the selected fallback condition information code to an NR base station associated with the UE device.

The NR base station may be configured to detect the fallback condition based on the fallback condition information code and initiate a fallback handover in response. For example, the NR base station may send a handover request to an LTE base station (which may be located at the same site or at a different site) and then send a Radio Resource Control (RRC) Reconfiguration message to the UE device, instructing the UE device to connect to the LTE base station. The UE device may thus be further configured to perform a fallback handover by receiving an instruction from the NR base station to connect to an LTE base station and connect to the LTE base station in response to receiving the instruction.

Detecting the fallback condition may include detecting an overheating condition in the UE device. Additionally, or alternatively, detecting the fallback condition may include at least one of determining that the UE device is using only one component carrier, determining that the UE device is using only one MIMO layer, or determining that the UE device has reduced throughput below a throughput threshold. Furthermore, detecting the fallback condition may include detecting that a battery life level for the UE device is below a battery life level threshold.

In some implementations, selecting the fallback condition information code based on the detected fallback condition may include sending a UE Assistance Information (UAI) to the NR base station with the selected fallback condition information code. UAI may be sent by a UE device to a base station as a RRC message that reports an internal status associated with the UE device to the base station.

In other implementations, selecting the fallback condition information code based on the detected fallback condition may include selecting a measurement report value outside an expected range for the measurement report value, and sending the selected fallback condition information code to the NR base station associated with the UE device may include sending a measurement report to the NR base station with the selected measurement report value. The selected measurement report value may include a single value or a sequence of two or more values.

The measurement report value may include a Signal to Interference and Noise Ratio (SINR) value, a Reference Signal Received Power (RSRP) value, a Reference Signal Received Quality (RSRQ) value, a Received Signal Strength Indicator (RSSI) value, a Channel Quality Indicator (CQI) value, a Block Error Rate (BLER) value, and/or another type of Key Performance Indicator (KPI) value included in a measurement report sent by the UE device to the base station. The measurement report values may be previously received from the NR base station in an instruction to use the measurement report values to report a particular fallback condition (e.g., a SINR=0, followed by SINR=1, followed by SINR=2, etc.). In some implementations, the measurement report values may correspond to unrealistic KPI values (e.g., values outside an expected range of possible values, etc.) such as SINR=100, SINR=101, etc., so that a base station is able to recognize the KPI values as a report of a fallback condition rather than as measured KPI values.

Since a measurement report that includes one or more measurement report values representing a fallback condition information code (e.g., an overheating condition, etc.) cannot be used by the network for anything other than detecting fallback and triggering a fallback handover, the UE device may be further configured to follow up with a measurement report that includes actually measured values for the KPIs associated with the selected measurement report value.

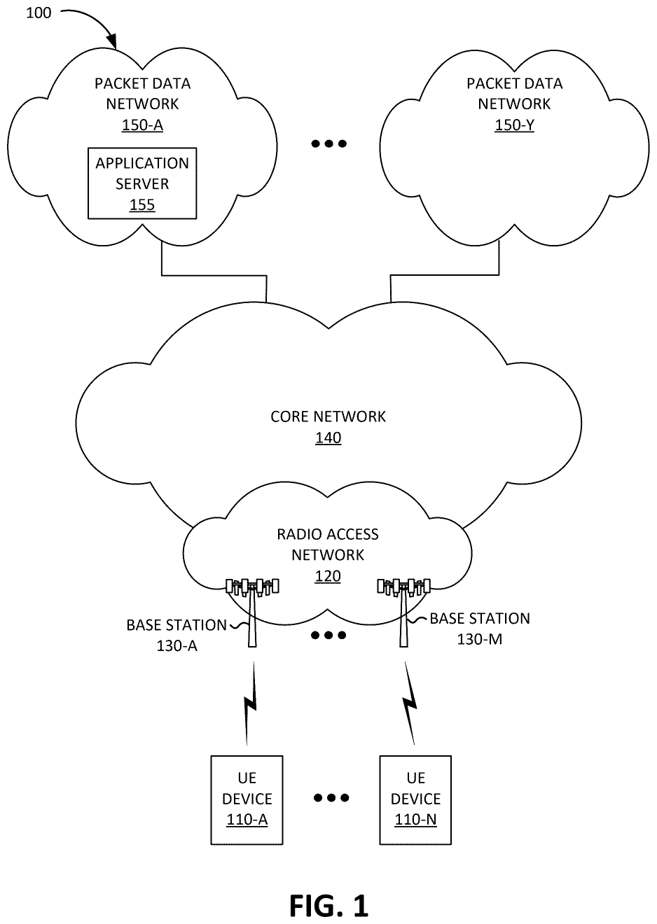

FIG. 1 is a diagram of an exemplary environment 100 in which the systems and/or methods described herein may be implemented. As shown in FIG. 1, environment 100 may include UE devices 110-A to 110-N (herein collectively referred to as “UE devices 110” and individually as “UE device 110”), a RAN 120 that includes base stations 130-A to 130-M herein collectively (herein collectively referred to as “base stations 130” and individually as “base station 130”), a core network 140, and packet data networks (PDNs) 150-A to 150-Y (herein collectively referred to as “PDNs 150” and individually as “PDN 150”).

UE device 110 may include any mobile device with cellular wireless communication functionality. UE device 110 may include a handheld wireless communication device (e.g., a mobile phone, a smart phone, a tablet device, etc.); a wearable computer device (e.g., a head-mounted display computer device, a wristwatch computer device, etc.); a laptop computer, a tablet computer, a portable gaming system, and/or another type of portable computer; a Fixed Wireless Access (FWA) device; and/or any other type of mobile computer device with cellular wireless communication capabilities. In some implementations, UE device 110 may communicate using machine-to-machine (M2M) communication, such as Machine Type Communication (MTC), and/or another type of M2M communication for IoT applications.

RAN 120 may include base stations 130 and be managed by a provider of wireless communication services. RAN 120 may enable UE devices 110 to connect to core network 140 via base stations 130 using cellular wireless signals. For example, RAN 120 may include one or more central units (CUs), distributed units (DUs), and/or Radio Units (RUs) (not shown in FIG. 1) that enable and manage connections from RUs to core network 140. RAN 120 may include features associated with an LTE Advanced (LTE-A) network and/or a 5G network or other next generation network, such as features for, or associated with, management of 5G NR base stations; carrier aggregation; advanced or massive Multiple-Input Multiple Output (MIMO) configurations (e.g., an 8×8 antenna configuration, a 16×16 antenna configuration, a 256×256 antenna configuration, etc.); cooperative MIMO (CO-MIMO); relay stations; Heterogeneous Networks (HetNets) of overlapping small cells and macrocells; Self-Organizing Network (SON) functionality; MTC functionality, such as 1.4 Megahertz (MHz) wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of LTE-A and/or 5G functionality.

Base station 130 may include a 5G NR base station (e.g., a gNodeB) and/or a 4G LTE base station (e.g., an eNodeB). Base stations 130 may include devices and/or components configured to enable cellular wireless communication with UE devices 110. For example, base stations 130 may include a radio frequency (RF) transceiver configured to communicate with UE devices 110 using a 5G NR air interface and a 5G NR protocol stack, a 4G LTE air interface and a 4G LTE protocol stack, and/or using another type of cellular air interface.

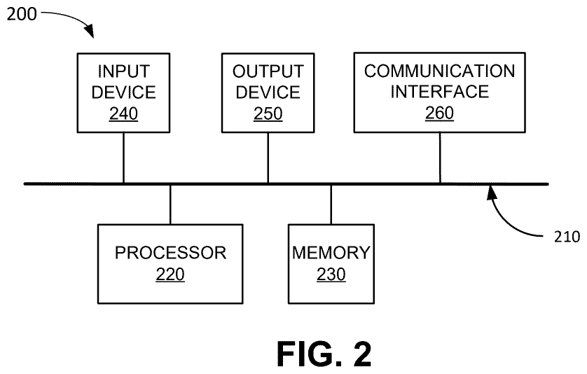

Core network 140 may be managed by the provider of cellular wireless communication services and may manage communication sessions of subscribers connecting to core network 140 via RAN 120. For example, core network 140 may establish an Internet Protocol (IP) connection between UE devices 110 and PDN 150. The components of core network 140 may be implemented as dedicated hardware components and/or as Virtual Network Functions (VNFs) implemented on top of a common shared physical infrastructure using Software Defined Networking (SDN). For example, an SDN controller may implement one or more of the components of core network 140 using an adapter implementing a VNF virtual machine, a Cloud-Native Network Function (CNF) container, an event driven serverless architecture, and/or another type of SDN architecture. The common shared physical infrastructure may be implemented using one or more devices 200 described below with reference to FIG. 2 in a cloud computing center associated with core network 140.

PDNs 150-A to 150-Y may each be associated with a Data Network Name (DNN) in 5G, and/or an Access Point Name (APN) in 4G. UE device 110 may request a connection to PDN 150 using a DNN or an APN. For example, UE device 110 may request a data flow connection to an application server 155 (shown in PDN 150-A). PDN 150 may include, and/or be connected to, a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks. PDN 160 may include application server 155. Application server 155 may include one or more computer devices that host one or more applications and/or other types of services used by UE device 110. Core network 140 may establish a communication session between UE device 110 and application server 155 via RAN 120.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 is a diagram illustrating example components of a device 200 according to an implementation described herein. The components of FIG. 1 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, central processing unit (CPU), graphics processing unit (GPU), tensor processing unit (TPU), hardware accelerator, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some implementations, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the user. In some implementations, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to RF signals and/or a receiver that converts RF signals to baseband signals. Communication interface 260 may be coupled to an antenna for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to a fallback mechanism in cellular wireless network. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally, or alternatively, one or more components of device 200 may perform one or more tasks described as being performed by one or more other components of device 200.

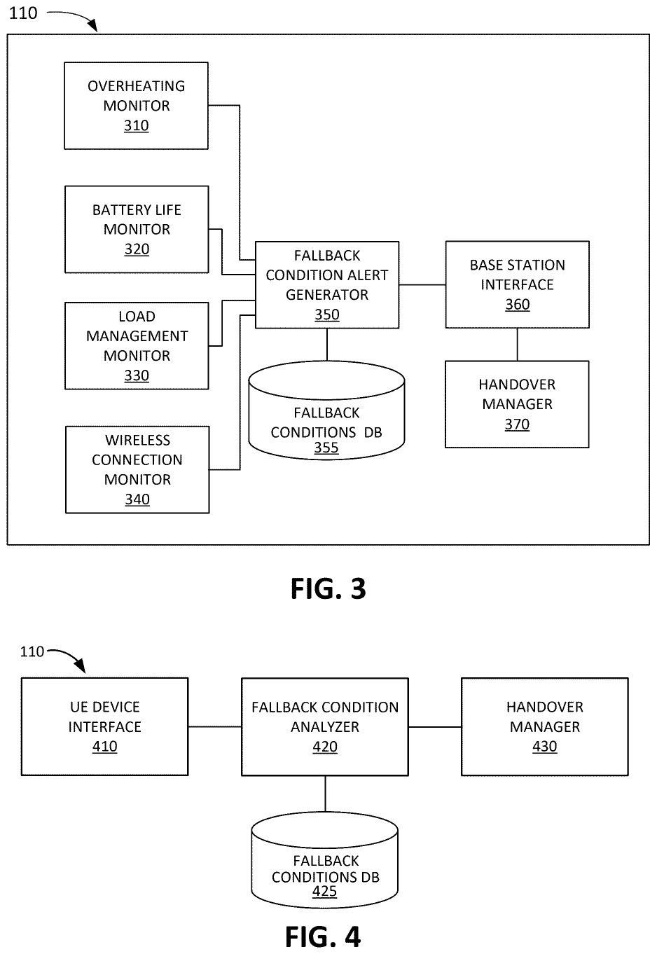

FIG. 3 illustrates exemplary components of UE device 110. The components of UE device 110 may be implemented, for example, via processor 220 executing instructions from memory 230. For example, one or more components of UE device 110 may correspond to the structure of processor 220 together with instructions in memory 230 for implementing the functionality of the component. Alternatively, some or all of the components of UE device 110 may be implemented via hard-wired circuitry. For example, one or more components of UE device 110 may correspond to the structure of some or all of an ASIC, FPGA, and/or another type of integrated circuit. As shown in FIG. 3, UE device 110 may include an overheating monitor 310, a battery life monitor 320, a load management monitor 330, a wireless connection monitor 340, a fallback condition alert generator 350, a fallback conditions database (DB) 355, a base station interface 360, and a handover manager 370.

Overheating monitor 310 may monitor for an overheating condition in UE device 110. For example, overheating monitor 310 may interface with an overheating sensor and/or associated functionality in UE device 110. Overheating monitor 310 may collect information relating a type of overheating event, one or more overheating thresholds that have been reached, and/or a duration for which particular overheating thresholds have been reached or exceeded, and/or other types of overheating information. Overheating monitor 310 may provide information relating to a detected overheating condition to fallback condition alert generator 350.

Battery life monitor 320 may monitor battery life for UE device 110. For example, battery life monitor 320 may monitor the remaining percentage of battery capacity, whether a battery life threshold has been reached, a rate of battery usage, and/or other types of battery life information. Battery life monitor 320 may provide information relating to a detected battery life condition (e.g., battery life falling below a threshold, etc.) to fallback condition alert generator 350.

Load management monitor 330 may monitor processing load for the wireless transceiver of UE device 110. For example, load management monitor 330 may determine the number of component carriers being used by UE device 110, the number of MIMO layers being used by UE device 110, the data throughput being processed by UE device 110, and/or other types of processing load associated with UE device 110. Load management monitor 330 may provide information relating to processing load for UE device 110 to fallback condition alert generator 350.

Wireless connection monitor 340 may monitor the status and/or quality of a wireless connection of UE device 110. For example, wireless connection monitor 340 may determine whether a wireless connection to base station 130 has failed or is associated with a signal quality that is below a signal quality threshold. Wireless connection monitor 340 may provide information relating to the status and/or quality of the wireless connection to fallback condition alert generator 350.

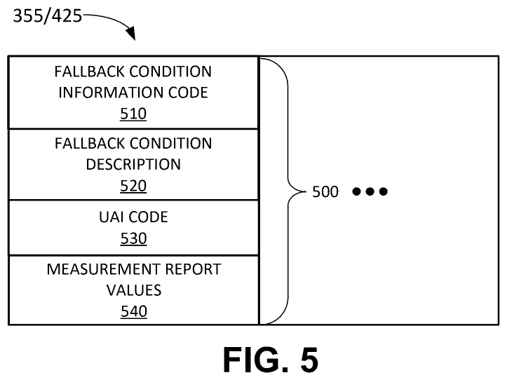

Fallback condition alert generator 350 may determine whether a fallback condition has been detected based on information obtained from overheating monitor 310, battery life monitor 320, load management monitor 330, and/or wireless connection monitor 340 and based on information stored in fallback conditions DB 355. Fallback conditions DB 355 may store information relating to particular fallback conditions and associated fallback condition information codes. Exemplary information that may be store in fallback conditions DB 355 is described below with reference to FIG. 5.

Fallback condition alert generator 350 may determine that a fallback condition has been detected, select a fallback condition information code from fallback conditions DB 355, and send the selected fallback condition information code to a gNodeB to which UE device 110 is connected. In some implementations, fallback condition alert generator 350 may include the fallback condition information code in a UAI message to the gNodeB.

In other implementations, the selected fallback condition information code may correspond to one or more KPI values for a measurement report KPI, such as, for example, SINR, RSRP, RSRQ, RSSI, CQI, BLER, and/or another KPI. The one or more KPI values may have been received from the gNodeB in an instruction to use the one or more measurement report values to report a particular fallback condition and/or may correspond to unrealistic values, such as values outside an expected range of possible values. Fallback condition alert generator 350 may send one or more measurement reports to the gNodeB with the one or more KPI values corresponding to the selected fallback condition information code. UE device 110 may then follow up with a measurement report that includes actually measured values for the KPIs associated with the selected measurement report value.

Base station interface 360 may be configured to communicate with base stations 120. For example, base station interface 360 may implement an N2 interface to communicate with a gNodeB base station 210. Furthermore, base station interface 360 may implement an LTE-Uu interface to communicate with an eNodeB base station 130. Handover manager 370 may be configured to perform handovers, such as inter-RAT fallback handovers from a 5G connection to a gNodeB to a 4G connection to an eNodeB.

Although FIG. 3 shows exemplary components of UE device 110, in other implementations, UE device 110 may include fewer components, different components, additional components, or differently arranged components than depicted in FIG. 3. Additionally, or alternatively, one or more components of UE device 110 may perform one or more tasks described as being performed by one or more other components of UE device 110.

FIG. 4 illustrates exemplary components of base station 130. The components of base station 130 may be implemented, for example, via processor 220 executing instructions from memory 230. For example, one or more components of base station 130 may correspond to the structure of processor 220 together with instructions in memory 230 for implementing the functionality of the component. Alternatively, some or all of the components of base station 130 may be implemented via hard-wired circuitry. For example, one or more components of base station 130 may correspond to the structure of some or all of an ASIC, FPGA, and/or another type of integrated circuit. As shown in FIG. 4, base station 130 may include a UE interface 410, a fallback condition analyzer 420, a fallback conditions DB 425, and a handover manager 430.

UE interface 410 may be configured to communicate with UE device 110. For example, UE interface 410 may implement a 5G N2 interface. Fallback condition analyzer 420 may analyze information relating to fallback conditions reported by UE device 110 and determine whether to perform a fallback handover based on the analyzed information and information stored in fallback conditions DB 425. Fallback conditions DB 425 may store information relating to particular fallback conditions and associated fallback condition information codes. Exemplary information that may be store in fallback conditions DB 425 is described below with reference to FIG. 5.

For example, fallback condition analyzer 420 may determine that a fallback condition has been detected by UE device 110, based on UAI information received from UE device 110, and/or based on one or more measurement report values received in one or more measurement reports received from UE device. In response to receiving the information from UE device 110, fallback condition analyzer 420 may initiate a fallback handover via handover manager 430. Handover manager 430 may manage handovers for base station 130. For example, handover manager 430 may select a target eNodeB for the fallback handover and send a handover request to the selected target eNodeB. Handover manager 430 may then send an RRC Reconfiguration message to UE device 110 instructing UE device 110 to attach to the selected target eNodeB. Handover manager 430 may further transfer any existing data sessions associated with UE device to the selected target eNodeB.

In some implementations, base station 130 may perform different actions based on different types of fallback conditions. As an example, base station 130 may perform a fallback Release with Redirection instead of a handover. As another example, base station 130 may select a particular 4G band and/or channel and recommend the selected 4G band and/or channel to the selected target eNodeB. As yet another example, base station 130 may instruct UE device 110 to perform an action in addition to, or instead of, the fallback handover. The instruction may include an instruction to reduce the number of component carrier, to reduce the number of MIMO layers, to reduce the throughput, and/or to perform another type of action. As yet another example, base station 130 may select multiple potential target eNodeBs and may instruct UE device 110 to perform a Conditional Handover (CHO) if a particular threshold and/or trigger condition is detected by UE device 110.

Although FIG. 4 shows exemplary components of base station 130, in other implementations, base station 130 may include fewer components, different components, additional components, or differently arranged components than depicted in FIG. 4. Additionally, or alternatively, one or more components of base station 130 may perform one or more tasks described as being performed by one or more other components of base station 130.

FIG. 5 illustrates exemplary components of fallback conditions DB 355/425. As shown in FIG. 5, fallback conditions DB 355/425 may include one or more fallback condition records 500. Each fallback condition record 500 may include information relating to a particular fallback condition. Fallback condition record 500 may include a fallback condition information code field 510, a fallback condition description field 520, a UAI code field 530, and a measurement report values field 540.

Fallback condition information code field 510 may store an information code associated with a particular fallback condition. Fallback condition description field 520 may include a description for the particular fallback condition such as an overheating condition, a particular type of overheating condition, a low battery condition, etc. Furthermore, in some implementations, fallback condition description field 520 may identify an action to be performed in connection with the particular fallback condition. UAI code field 530 may store information identifying a UAI code associated with the particular fallback condition. Measurement report values field 540 may store information identifying one or more KPI values, for a KPI included in a measurement report sent by UE device 110 to base station 130, which are associated with the particular fallback condition detected by UE device 110. The KPI values may include, for example, SINR values, RSRP values, RSRQ values, RSSI values, CQI values, BLER values, and/or other KPI values.

Although FIG. 5 shows exemplary components of fallback conditions DB 355/425, in other implementations, fallback conditions DB 355/425 may include fewer components, different components, additional components, or differently arranged components than depicted in FIG. 5.

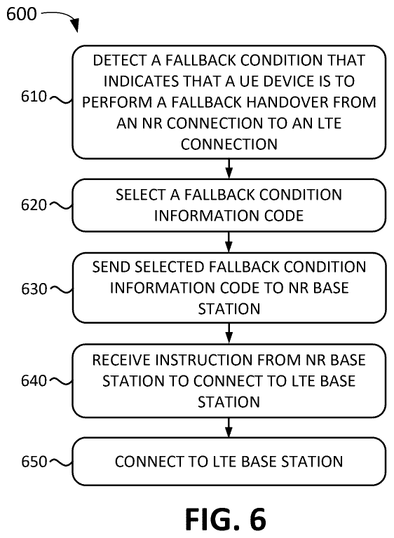

FIG. 6 illustrates a flowchart of a process 600 for reporting a fallback condition. In some implementations, process 600 of FIG. 6 may be performed by UE device 110. In other implementations, some or all of process 600 may be performed by another device or a group of devices separate from UE device 110.

As shown in FIG. 6, process 600 may include detecting a fallback condition that indicates that a UE device is to perform a fallback handover from an NR connection to an LTE connection (block 610). For example, UE device 110 may detect an overheating condition and may, in response, reduce the number of component carriers, reduce the number of MIMO layers, and/or reduce throughput for any active communication sessions in order to end the overheating condition. If the overheating condition persists, UE device 110 may determine that a fallback condition is detected for a fallback handover from an NR connection to an LTE connection.

As another example, UE device 110 may determine that the battery capacity of UE device 110 is below a battery capacity threshold and may determine that a fallback condition is detected for a fallback handover from an NR connection to an LTE connection, as an LTE connection may use less power than an NR connection.

Process 600 may further include selecting a fallback condition information code (block 620) and sending the selected fallback condition information code to an NR base station (block 630). As an example, UE device 110 may send a UAI message to gNodeB (e.g., base station 130 to which UE device 110 is connected) with a fallback condition information code corresponding to the detected fallback condition. As another example, UE device 110 may send one or more measurement reports to the gNodeB with the one or more KPI values corresponding to the selected fallback condition information code, such as one or more SINR values, RSRP values, RSRQ values, RSSI values, CQI values, BLER values, and/or other KPI values. The KPI values may correspond to unrealistic values, such as values outside an expected range of possible values for a particular KPI. UE device 110 may then follow up with a measurement report that includes actually measured values for the KPIs associated with the selected measurement report value.

Process 600 may further include receiving an instruction from the NR base station to connect to an LTE base station (block 640) and connecting to the LTE base station (block 650). For example, UE device 110 may receive an RRC Reconfiguration message from the gNodeB instructing UE device 110 to connect to an eNodeB identified in the RRC Reconfiguration message. UE device 110 may send an RRC Reconfiguration Complete message to the gNodeB and may then connect to the identified eNodeB.

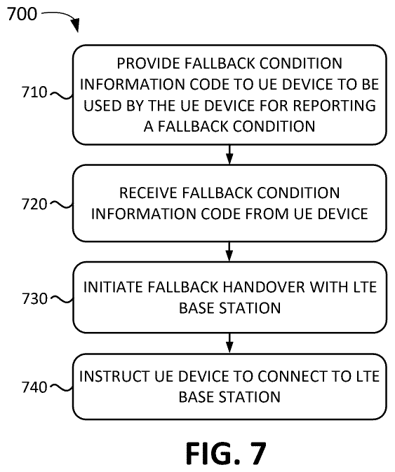

FIG. 7 illustrates a flowchart of a process 700 for performing a handover based on a fallback condition. In some implementations, process 700 of FIG. 7 may be performed by base station 130. In other implementations, some or all of process 700 may be performed by another device or a group of devices separate from base station 130.

As shown in FIG. 7, process 700 may include providing a fallback condition information code to a UE device to be used by the UE device for reporting a fallback condition (block 710). For example, base station 130 may generate a set of fallback condition information codes corresponding to a set of different fallback conditions. For example, base station 130 may generate a set of UAI codes for different fallback conditions, such as an overheating fallback condition, an overheating condition associated with a particular temperature or duration threshold, a low battery fallback condition, a signal connection failure fallback condition, and/or another type of fallback condition.

As another example, base station 130 may generate, for each fallback condition, one or more KPI values to represent the fallback condition. The one or more KPI values may include SINR values, RSRP values, RSRQ values, RSSI values, CQI values, BLER values, and/or other KPI values. The KPI values may be selected as values that are outside an expected range of possible values for a particular KPI so that base station 130 is able to recognize the KPI values as a report of a fallback condition rather than as measured KPI values. Base station 130 may send an instruction to UE device 110 to use the generated set of fallback condition information codes during a configuration process of UE device 110 when UE device 110 registers with RAN 120 and/or core network 140.

Process 700 may further include receiving a fallback condition information code from the UE device (block 720), initiating a fallback handover with an LTE base station (block 730), and instructing the UE device to connect to the LTE base station (block 740). For example, base station 130 may receive a UAI message from UE device 110 with a fallback condition information code indicating a particular fallback condition. As another example, base station 130 may receive one or more measurement reports that include one or more KPI values corresponding to a fallback condition. In response, base station 130 may select an eNodeB, which may be located on the same site or on a different site, and may send a handover request to the selected eNodeB. Base station 130 may then send an RRC Reconfiguration message to UE device 110 instructing UE device 110 to attach to the selected eNodeB. Base station 130 may further transfer any existing data sessions associated with UE device to the selected target eNodeB.

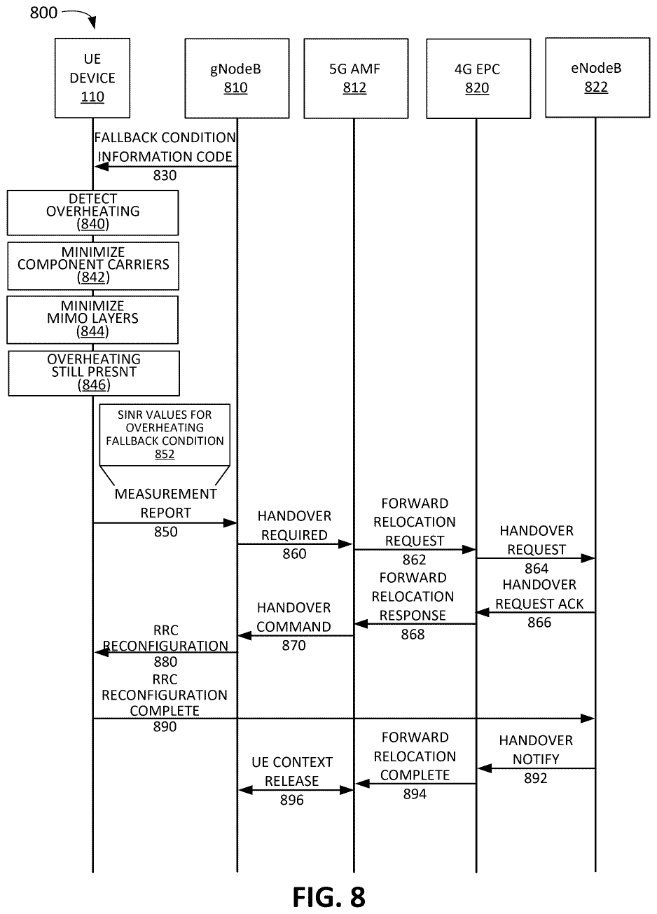

FIG. 8 illustrates an exemplary signal flow diagram 800 according to an implementation described herein. As shown in FIG. 8, signal flow diagram 800 may include gNodeB 810 proving a fallback condition information code to UE device 110 (signal 830). For example, gNodeB 810 may send a set of SINR values to UE device 110 along with an instruction to use the UAI code and/or set of SINR values to report a fallback condition based on overheating.

At a later time, UE device 110 may detect an overheating condition (block 840). In response, UE device 110 may minimize the number of component carriers (block 842) and may minimize the number of MIMO layers (block 844) in order to reduce the load on the wireless transceiver. UE device 110 may determine that overheating is still present (block 846) and determine that a fallback condition exists. In response, UE device 110 may send a measurement report (signal 850) to gNodeB 812 with the received set of SINR values 852 indicating an overheating fallback condition.

gNodeB 810 may receive the measurement report and detect the overheating fallback condition based on the included set of SINR values. In response, gNodeB 810 may initiate a fallback handover by sending a Handover Required message (signal 860) to 5G Access and Mobility Management Function (AMF) 812. 5G AMF 812 may then forward a relocation request (signal 862) to 4G Evolved Packet Core (EPC) 814, such as to a Mobility Management Entity (MME) in 4G EPC 820. 4G EPC 820 may then send a handover request to the nearest and/or selected eNodeB 822 (signal 864).

eNodeB 822 may send back a handover request acknowledgement (signal 866) back to 4G EPC 814. 4G EPC 814 may send a forward relocation response (signal 868) back to 5G AMF 812 and 5G AMF 812 may send a Handover Command to gNodeB 810 (signal 870). gNodeB 810 may then send an RRC Reconfiguration message to UE device 110 with information identifying the selected eNodeB 822 (signal 880). UE device 110 may respond with an RRC Reconfiguration Complete message (signal 882). UE device 110 may then send a handover confirmation message to eNodeB 822 (signal 890). eNodeB 822 may complete the fallback handover by sending a Handover Notify message to 4G EPC 820 (signal 892). 4G EPC 820 may send a forward relocation response to 5G AMF 812 (signal 894) and 5G AMF 812 may send a UE Context Release message to gNodeB 810 (signal 896). In response, gNodeB 810 may release the resources reserved for UE device 110, thereby completing the handover.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 6 and 7, and a series of signals have been described with respect to FIG. 8, the order of the blocks, and/or signals, may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
detecting, by a user equipment (UE) device, a fallback condition, wherein the fallback condition indicates that the UE device is to perform a fallback handover from a New Radio (NR) cellular wireless connection to a Long Term Evolution (LTE) cellular wireless connection;
selecting, by the UE device, a fallback condition information code based on the detected fallback condition;
sending, by the UE device, the selected fallback condition information code to an NR base station associated with the UE device;
receiving, by the UE device, an instruction from the NR base station to connect to an LTE base station; and
connecting, by the UE device, to the LTE base station in response to receiving the instruction to connect to the LTE base station.

2. The method of claim 1, wherein detecting the fallback condition includes detecting an overheating condition in the UE device.

3. The method of claim 2, wherein detecting the fallback condition further includes at least one of:
determining that the UE device is using only one component carrier;
determining that the UE device is using only one Multiple Input Multiple Output (MIMO) layers; or
determining that the UE device has reduced throughput below a throughput threshold.

4. The method of claim 1, wherein detecting the fallback condition includes detecting that a battery life level for the UE device is below a battery life level threshold.

5. The method of claim 1, wherein selecting the fallback condition information code based on the detected fallback condition includes:
selecting a measurement report value outside an expected range for the measurement report value; and
wherein sending the selected fallback condition information code to the NR base station associated with the UE device includes:
sending a measurement report to the NR base station with the selected measurement report value.

6. The method of claim 5, wherein the selected measurement report value includes at least one of:
a Signal to Interference and Noise Ratio (SINR) value,
a Reference Signal Received Power (RSRP) value,
a Reference Signal Received Quality (RSRQ) value,
a Received Signal Strength Indicator (RSSI) value,
a Channel Quality Indicator (CQI) value, or
a Block Error Rate (BLER) value.

7. The method of claim 5, wherein the selected measurement report value includes a sequence of at least two particular measurement report values.

8. The method of claim 5, further comprising:
sending another measurement report to the NR base station, wherein the other measurement report includes a measured value for a parameter associated with the selected measurement report value.

9. The method of claim 5, further comprising:
receiving, from the NR base station, an instruction to use the selected measurement report value to report the fallback condition.

10. The method of claim 1, wherein sending the selected fallback condition information code to the NR base station associated with the UE device includes:
sending a UE Assistance Information (UAI) to the NR base station with the selected fallback condition information code.

11. A user equipment (UE) device comprising:
a processor configured to:
detect a fallback condition, wherein the fallback condition indicates that the UE device is to perform a fallback handover from a New Radio (NR) cellular wireless connection to a Long Term Evolution (LTE) cellular wireless connection;
select a fallback condition information code based on the detected fallback condition;
send the selected fallback condition information code to an NR base station associated with the UE device;
receive an instruction from the NR base station to connect to an LTE base station; and
connect to the LTE base station in response to receiving the instruction to connect to the LTE base station.

12. The UE device of claim 11, wherein, when detecting the fallback condition, the processor is further configured to detect an overheating condition in the UE device.

13. The UE device of claim 12, wherein, when detecting the fallback condition, the processor is further configured to at least one of:
determine that the UE device is using only one component carrier;
determine that the UE device is using only one Multiple Input Multiple Output (MIMO) layers; or
determine that the UE device has reduced throughput below a throughput threshold.

14. The UE device of claim 11, wherein, when detecting the fallback condition, the processor is further configured to detect that a battery life level for the UE device is below a battery life level threshold.

15. The UE device of claim 11, wherein, when selecting the fallback condition information code based on the detected fallback condition, the processor is further configured to:
select a measurement report value outside an expected range for the measurement report value; and
wherein, when sending the selected fallback condition information code to the NR base station associated with the UE device, the processor is further configured to:
send a measurement report to the NR base station with the selected measurement report value.

16. The UE device of claim 15, wherein the selected measurement report value includes at least one of:
a Signal to Interference and Noise Ratio (SINR) value,
a Reference Signal Received Power (RSRP) value,
a Reference Signal Received Quality (RSRQ) value,
a Received Signal Strength Indicator (RSSI) value,
a Channel Quality Indicator (CQI) value, or
a Block Error Rate (BLER) value.

17. The UE device of claim 15, wherein the selected measurement report value includes a sequence of at least two particular measurement report values.

18. The UE device of claim 15, wherein the processor is further configured to:
receive, from the NR base station, an instruction to use the selected measurement report value to report the fallback condition.

19. The UE device of claim 11, wherein, when sending the selected fallback condition information code to the NR base station associated with the UE device, the processor is configured to:
send a UE Assistance Information (UAI) to the NR base station with the selected fallback condition information code.

20. A non-transitory computer-readable memory device storing instructions executable by a processor, the non-transitory computer-readable memory device comprising:
one or more instructions to detect a fallback condition, wherein the fallback condition indicates that a user equipment (UE) device is to perform a fallback handover from a New Radio (NR) cellular wireless connection to a Long Term Evolution (LTE) cellular wireless connection;
one or more instructions to select a fallback condition information code based on the detected fallback condition;
one or more instructions to send the selected fallback condition information code to an NR base station associated with the UE device;
one or more instructions to receive an instruction from the NR base station to connect to an LTE base station; and
one or more instructions to connect to the LTE base station in response to receiving the instruction to connect to the LTE base station.
